(19) United States
(12) Patent Application Publication
(10) Pub. No.: US 2010/0290372 A1
(43) Pub. Date: Nov. 18, 2010

(54) METHOD FOR MULTIPLE TDD SYSTEMS COEXISTENCE

(75) Inventors: Chuan Zhong, Beijing (CN); Hong He, Beijing (CN); Xufeng Zheng, Beijing (CN); Zongchuang Liang, Beijing (CN); Ho-Kyu Choi, Seongnam-si (KR); Jae-Weon Cho, Suwon-si (KR); Jung-Je Son, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO., LTD., Suwon-city, Gyeonggi-do (KR)

(21) Appl. No.: 12/811,619

(22) PCT Filed: Jan. 9, 2009
(86) PCT No.: PCT/KR09/00125

§ 371 Date: Jul. 2, 2010

(30) Foreign Application Priority Data
Jan. 9, 2008 (CN) 200810002586.X

(51) Int. Cl. H04J 3/00; H04L 5/14; H04B 7/216

(52) U.S. Cl. 370/280; 370/294

(57) ABSTRACT

The method for multiple TDD systems coexistence comprising steps of: a newly deployed system calculating a relative time offset Δt for a corresponding frame; the newly deployed system transmitting uplink and downlink signals based on a time reference information obtained by a summation of the relative time offset Δt and a time reference of an existing system. With the method proposed in present invention, uplink and downlink interference from adjacent frequency bands and from adjacent carriers in the same frequency band can be greatly reduced and a transmission time utility can be guaranteed for a newly deployed system.

### TECHNICAL FIELD

Present invention relates to two or more TDD wireless communication systems, especially to a design of frame structure and system for multiple TDD (Time Division Duplex) systems coexistence.

### BACKGROUND ART

At present, typical TDD systems in a field of wireless mobile communications include a TD-SCDMA (time-division synchronization code-division multiple access) system, a mobile broadband wireless access system based on IEEE 802.16e standard (i.e., the mobile WiMAX system, Mobile Worldwide Interoperability for Microwave Access) and a TDD system (IEEE 802.16m TDD) defined in IEEE 802.16m which is under standardization.

As a TDD leading technique in the 3^{rd} generation mobile communication system, TD-SCDMA network has been widely deployed in China. The applied and alternative frequency bands include 1880˜1920 MHz, 2010˜2025 MHz, 2300˜2400 MHz and the 2496˜2690 MHz which is in consideration.

The technique of mobile WiMAX is based on IEEE 802.16e standard. Proposed by a WiMAX forum industry union, it is experiencing rapid development and striving to be a candidate technique for the 3^{rd} generation mobile communication system approved by ITU. By far, planned frequency bands include 2300˜2400 MHz, and 2500 MHz and 3300 MHz. And recommended frequency band in China include 2305˜2320 MHz, 2345˜2360 MHz and 2496˜2690 MHz.

IEEE 802.16m is an evolved system from IEEE 802.16e to meet technical requirements of next generation of IMT-Adv system. Current IMT-Adv within 2300˜2400 MHz has allocated frequency bands for TDD systems. Since both TD-SCDMA and IEEE 802.16m TDD adopt the technique of TDD, and the frequency bands (2300˜2400 MHz) applied by the two systems are very close to each other, the coexistence of the two system is under key focus from many organizations like an operating enterprise, a manufacturing enterprise, academics, etc.

In summary, it is necessary to research the coexistence of TD-SCDMA system and the IEEE 802.16m-based system during a process of researching, standardizing and spreading a technique of IEEE 802.16m. Moreover, appealed by enterprises like China Mobile, the IEEE 802.16m standardization organization has written a problem of coexistence (the coexistence between adjacent frequency bands and the coexistence between adjacent carriers in the same frequency band) between mobile WiMAX and TD-SCDMA in the IEEE 802.16m technical requirements document under approving (see Reference 1 (IEEE802.16, C80216m-07_{—}002r4_Draft TGm Requirements Document).

By far, no consideration or design to the problem of coexistence between TDD system, especially to the coexistence between the TD-SCDMA system and the mobile WiMAX system, is done in Reference or discussions, although some relevant analysis and simulation are done to this problem.

Existing analysis on system coexistence is done to the researches of interference from adjacent carriers in the same frequency band, such as research of the same address interference, research of the adjacent address interference and so on. In Reference 2 (BUPT, the research report on the coexistence between TC5 WG3&WG8_{—}2007_{—}011_TD-SCDMA system and the 802 16e system), interference coexistence between a TD-SCDMA system and a mobile/fixed WiMAX system has been researched.

Simulations to the interference between systems have been done with different parameters (including a distance between BSs, a isolation between adjacent frequency bands, etc.) to obtain relevant interference data.

By far, no research result is published to other problems related to the coexistence of TD-SCDMA system and IEEE 802.16m-based system, for the research is in the prophase of standardization.

Interferences in a TDD system are different from that in an FDD (Frequency Division Duplex) system.

In an FDD system, interferences between channels only exist between the mobile stations and the base-stations, since an uplink and a downlink are in FDD mode. Therefore, a downlink channel only causes interference to downlink channels, and an uplink channel only causes interference to uplink channels. No interference will be caused by any uplink channel to downlink channels or vice versa.

However, in a TDD system, since the uplink shares the same carrier with the downlink, interferences may possible exist between mobile sets and base-stations. And the interference ratio is determined by the frame synchronization and symmetry of the slot between transmitting and receiving.

As seen from FIG. 1, following interferences are caused since an uplink time slot or a downlink time slot of BS1 is not aligned with that of BS2:
transmission of BS2 causes interference (101) to the receiving of BS1

Since the BS has high transmitting power and good transmitting conditions (in general, it has a higher transmitting antenna so that it has larger coverage), greater interference is caused between BSs.
transmitting for MS1 causes interference (102) to receiving for MS2

When the MSs locate at edges of corresponding cells and are not far from one another, greater interference will be caused from the interference.

The interferences exist in the case that the BSs of two or more TDD wireless communication systems are either in the same addresses or in different addresses.

### DISCLOSURE OF INVENTION

### Technical Solution

An object of this invention is to provide a method for multiple TDD systems coexistence.

A method for multiple TDD systems coexistence comprising steps of:

a newly deployed system calculating a relative time offset Δt for a corresponding frame;

the newly deployed system transmitting uplink and downlink signals based on a time reference information obtained by a summation of the relative time offset Δt and a time reference of an existing system.

With the method proposed in present invention, uplink and downlink interference from adjacent frequency bands and from adjacent carriers in the same frequency band can be greatly reduced and a transmission time utility can be guaranteed for a newly deployed system.

### BRIEF DESCRIPTION OF THE DRAWINGS

FIG. 1 shows possible interferences in multiple TDD systems coexistence;

FIG. 2(a) illustrates a flow of designing multiple TDD systems coexistence of;

FIG. 2(b) is a schematic diagram of designing multiple TDD systems coexistence;

FIG. 3 shows a TD-SCDMA frame structure;

FIG. 4 shows a mobile WiMAX frame structure;

FIG. 5(a) shows an IEEE 802.16m frame structure (symbol-based);

FIG. 5(b) shows an IEEE 802.16m frame structure (sub-frame-based);

FIG. 6 shows interferences between a TD-SCDMA system and IEEE 802.16m TDD system, in which the two systems share a same frame start time;

FIG. 7(a) is the schematic diagram showing the coexistence of TD-SCDMA (4:3) system and IEEE 802.16m TDD system;

FIG. 7(b) is the schematic diagram showing the coexistence of TD-SCDMA (5:2) system and IEEE 802.16m TDD system.

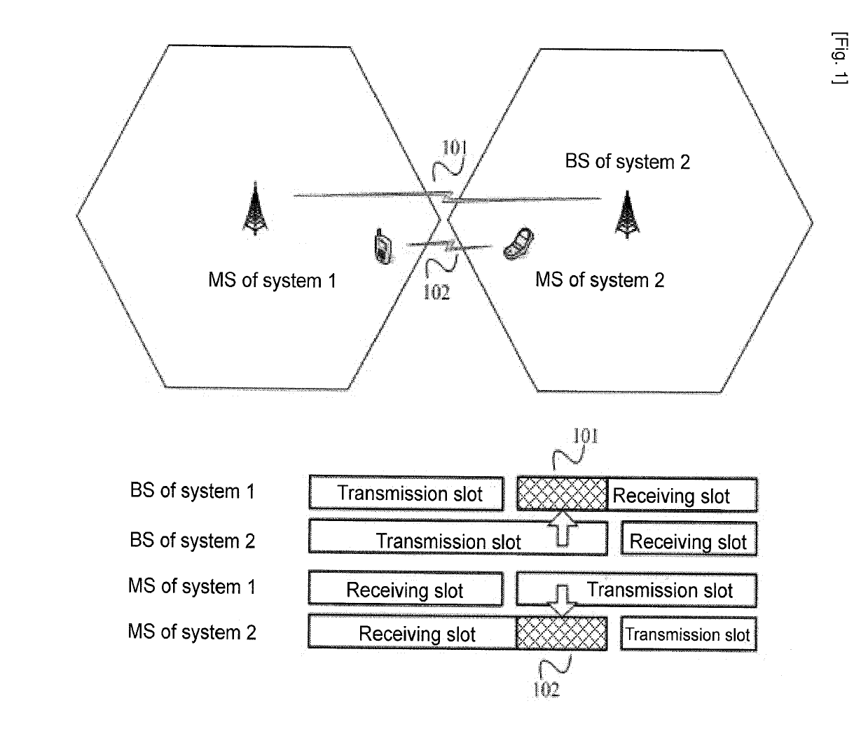

### BEST MODE FOR CARRYING OUT THE INVENTION

From a point of view of system design and system implementation, present invention provides a method to reduce the interferences between the systems in the coexistent two or more TDD systems, especially to reduce the interferences resulted from the coexistence of adjacent frequency bands and the coexistent adjacent carriers in the same frequency band for the coexistent TD-SCDMA, mobile WiMAX and IEEE 802.16m TDD. On this basis, slots are reasonably configured for uplink and downlink trans-missions to improve transmission efficiency of the system and protect significant slots so as to realize the coexistence of two or more TDD systems.

By an order of deploying the two systems coexisted in a communication system, the systems are denoted as an existing system and a newly deployed system respectively. In general, in a communication system, it is required that the newly deployed system should not cause any interference to operation of the existing system.

Therefore, in present invention, the originally deployed system can also be considered as a preferred system, and the newly deployed system is a secondary preferred system. It is required to reduce the interference from the secondary preferred to the existing as minimum as possible.

In an actual coexistence system, it is generally required that the newly deployed system should not cause any interference to the operation of the existing system.

For example, if it is necessary for IEEE 802.16m system to implement the deployment of adjacent carriers in the same frequency band in a deployed TD-SCDMA system, then the TD-SCDMA system is the existing system, and the IEEE 802.16m system is a newly deployed one. In general, it is required that the IEEE 802.16m system should not cause any interference to the operation of the TD-SCDMA system.

In following detailed description, the originally deployed system is called system 1 and the newly deployed system is called system 2.

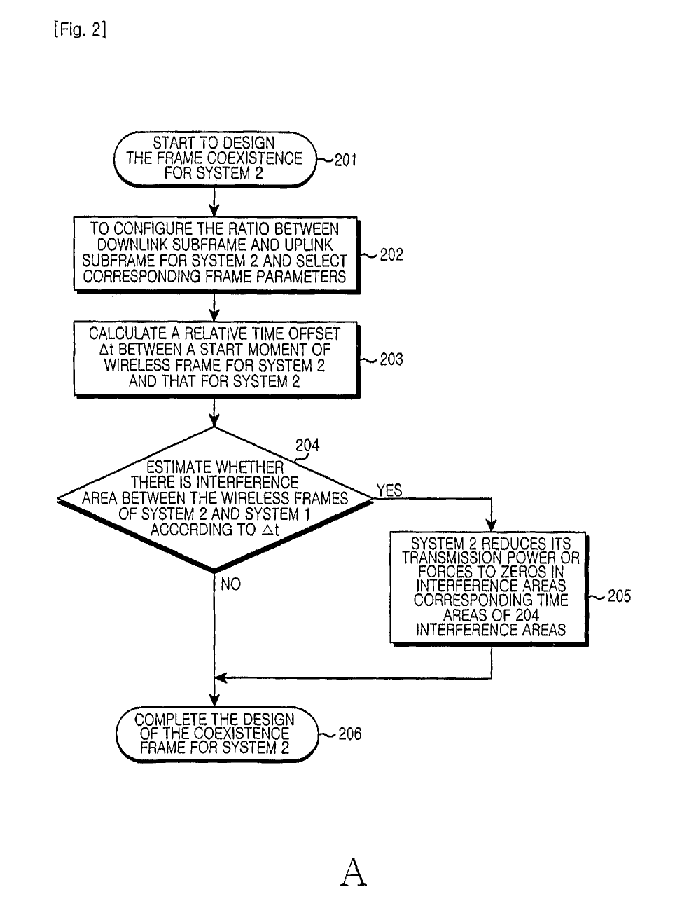

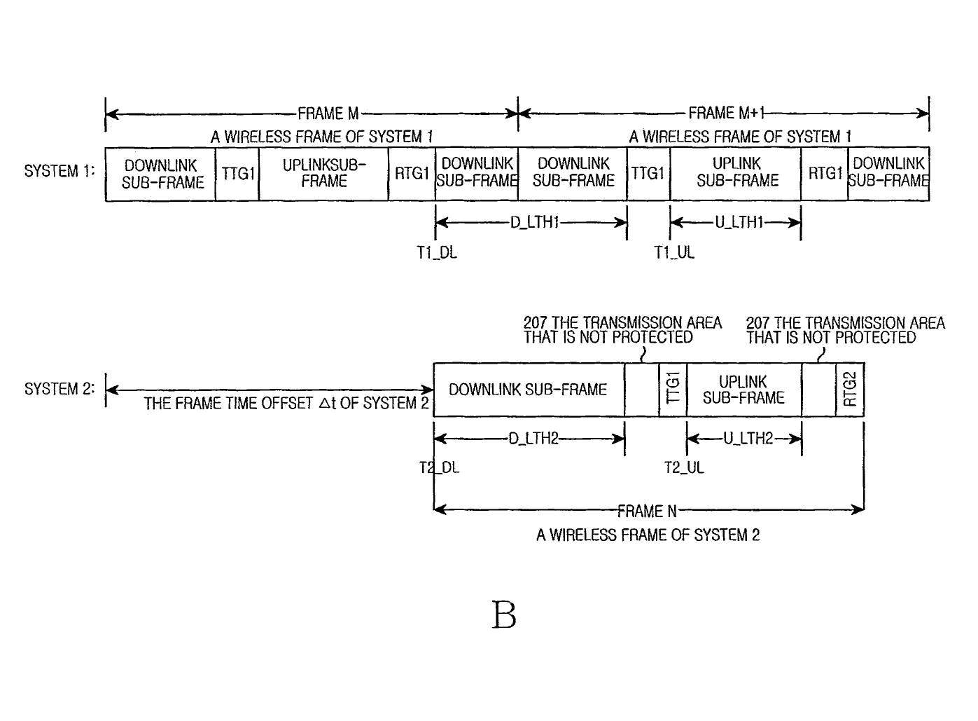

FIG. 2(a) shows a design flow of present invention, and FIG. 2(b) shows a design flow in schematic diagram. Following are detailed explanations, where steps 3 and 4 are necessary, while steps 1, 2, 5 and 6 are optional. The design flow of present invention contains following one or more steps or a combination of the steps in a preset order:

Step 1: the design of coexistent frames for system 2 starts;

Step 2 (204): a sub-frame ratio between downlink and uplink for system 2 is set, and then a corresponding frame parameter is selected;

To improve the utility of wireless transmission resources in the coexistent systems, it is necessary to occupy the uplink and downlink transmission time slots as many as possible on an assumption that demand on the interference between the systems can be well met. Therefore, in order to reduce the interference time area between system 1 and system 2, the sub-frame ratio between downlink and uplink can be determined for system 2 according to that for system 1. In general, the two ratios are kept consistent. By this ratio, the frame parameters including the lengths of uplink and downlink frames and the uplink/downlink transition periods (TTG and RTG) are determined.

This ratio may have several values. Coexistence design is implemented corresponding to each ratio.

Step 3 (201): a relative time offset Δt between a start moment of wireless frame for system 2 and that for system 1 is calculated

After the frame parameters are configured for system 2, the concept of the relative time offset Δt of start time moment of the wireless frames between system 2 and system 1 is introduced in present invention. Δt indicates a time difference between the start moment T2 of wireless frame N for system 2 and the start moment T1 of wireless frame for the system 1 (e.g., frame M) whose start moment is closest to that of frame N for system 2, i.e.

Δt=T2−T1 and 0≦Δt<frame length.

A process to determine the relative time offset Δt of wireless frame between system 2 and system 1 contains following one sub-step or the combination of sub-steps in the preset order:

Sub-step 1: system 2 obtains information on clock source and/or start moment of frame for system 1

Following two scenarios may be included:

a) The newly deployed system can directly obtain the information on the clock source and/or start moment for the frame of the existing system.

This scenario happens in a case that the two systems belong to the same operator.

The newly deployed system can either use the clock source of the existing system as its own or as the input of its clock phase lock loop (PLL).

b) The newly deployed system is not able to directly obtain the clock source of the existing system.

This scenario happens in the case that the two systems belong to the same operator.

With a receiver in the existing system, the newly deployed system can obtain the clock source of the existing system as its own from the received signal, or as an input of its clock phase lock loop.

Sub-step 2: the relative time offset Δt between the start moment of wireless frame in system 2 and that for system 1 is calculated

Δt can be calculated with one of the methods listed below, or with a combination of them. And in the case of calculating with a combination of two or more listed methods, Δt is within a range of the intersection of results obtained with the applied methods (among the obtained results, the larger is an upper bound, and the smaller is a lower bound)

For the convenience of description, following parameters are introduced:

Frame Length: FL. The frame length for system 1 is aligned with that for system 2.

Parameters of system 1:
length of slot for uplink transmission: U_LTH1
length of slot for downlink transmission: D_LTH1
start moment of transmitting an uplink sub-frame: T1_UL
start moment of transmitting a downlink sub-frame: T1_DL
TTG length: TTG1
RTG length: RTG1

Parameters of system 2:
length of slot for uplink transmission: U_LTH2
length of slot for downlink transmission: D_LTH2
start moment of transmitting an uplink sub-frame: T2_UL
start moment of transmitting a downlink sub-frame: T2_DL
TTG length: TTG2
RTG length: RTG2

Method 1:

Firstly, the reference time for the system 1 is aligned with that for the system 2. In this case, the transmission time start point of the system 1 is the same as that of system 2. Then a downlink transmission time point for system 1 (which is a downlink transmission start point immediately next to the uplink-downlink switching point TTG), denoted by T1 is recorded; and a time point of the downlink transmission that is adjacent previous immediately to T1 for system 2 (which is a downlink transmission start point immediately next to the uplink-downlink switching point TTG), denoted by T2 is recorded. At denotes a difference T1−T2.

Method 2:

Firstly, the reference time for system 1 is aligned with that for system 2. In this case, the transmission time start point of the system 1 is the same as that of system 2. Then an uplink transmission time point for system 1 (which is an uplink transmission start point immediately next to the uplink-downlink switching point RTG), denoted by T1; and record the time point of the uplink transmission that is adjacent but previous to T1 for system 2 (which is the uplink transmission start point next to the RTG immediately), denoted by T2. At denotes the difference T1−T2.

Method 3:

Suppose the lower bound of Δt be: (T1_UL−T2_DL−D_LTH2−TTG2) MOD (FL)

Suppose the upper bound of Δt be: (T1_DL−T2_UL−D_UTH2) MOD (FL)

Where (A)MOD(B) refers to the common modulo operation, i.e., modulo A with B.

Δt is greater than or equal to the lower bound but less than the upper bound.

That is to say, system 2 needs to meet the requirement that uplink transmission time slots for all newly deployed systems are included in that of the existing system. i.e., the uplink transmission can not be implemented before the downlink transmission end point of system 1; meanwhile, the uplink transmission should not be finished later than the downlink transmission start point of system 1.

Method 4:

Suppose a lower bound of Δt be: (T1_DL−T2_UL−D_UTH2−RTG2) MOD (FL)

Suppose an upper bound of Δt be: (T1_UL−T2_DL−D_DTH2) MOD (FL)

Where (A)MOD(B) refers to a common modulo operation, i.e., modulo A with B.

Δt is greater than or equal to the lower bound but less than the upper bound.

That is to say, system 2 needs to meet the requirement that all downlink transmission slots for system 2 are included in that of the existing system, i.e., the downlink transmission can not be implemented later than the downlink transmission end point of system 1; meanwhile, the downlink transmission should not be implemented before the downlink transmission start point of system 1.

Step 4 (202): a timing for system 2 is increased by offset Δt with respect to that for system 1, and the time reference in system 1 is added. System 2 uses the summation as its time reference for transmissions of uplink and downlink signals.

Step 5 (205): to estimate whether there is an interference area between the wireless frames of system 2 and system 1.

Whether there exists any interference time area or not is determined according to the projection areas of system 2 and system 1 on the time axis. If system 2's uplink and downlink transmission projection time slots exceed that of system 1, we determine that there exists some interference time area.

Step 6 (203): system 2 reduces its transmission power or forces to zeros in corresponding interference time areas (206) and/or in protected significant slots for system 1.

If system 2 finds out that there exists relevant interference time area and/or the system 1's protected significant slots, system 2 reduces its transmission power or forces to zero to reduce interference to system 1 under the coexistence environment.

The protected significant slots include but are not limited to a pilot transmission slot, a signaling transmission slot, a feedback information transmission slot, an uplink access slot, a synchronization slot and a distance sounding slot.

To reduce or zero enforcing the transmission power of all or some systems' all or some transmission slots or symbols such as puncturing, protection can be provided to interference slots and/or significant slots in two or more systems.

Step 7: Complete the design of the coexistence frame for system 2

### EMBODIMENT

The coexistence of a TD-SCDMA system and an IEEE 802.16m TDD system is taken in present invention as an embodiment to explain the design of a multi-TDD coexistence system.

Here, the TD-SCDMA refers to system 1, and IEEE802.16m TDD refers to system 2.

TD-SCDMA Frame Structure

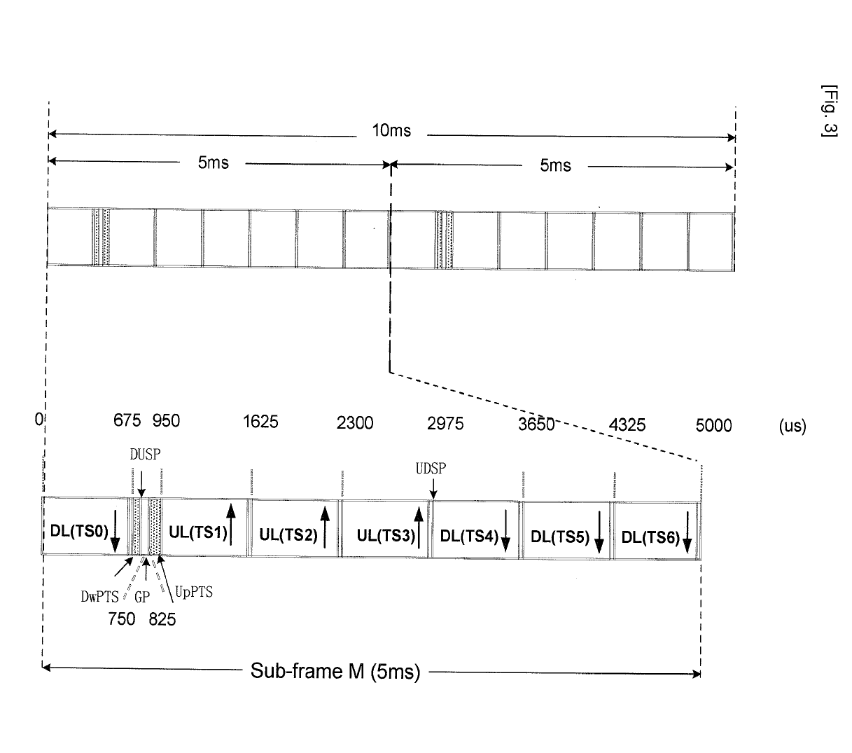

A TD-SCDMA frame structure is illustrated in FIG. 3. Where, the frame is 10 ms long, including two sub-frames with each being 5 ms long. The two sub-frames share the same length and the same structure. Here, a TD-SCDMA sub-frame (5 ms) contains 7 common time slots (TS0˜TS6), a downlink pilot time slot (DwPTS), an uplink pilot time slot (UpPTS) and a guard period (GP). The switch points (DUSP and UDSP) are the boundary between uplink slots and downlink time slots. By this boundary point, ratio between the numbers of uplink and downlink slots can be adjusted to adapt to the asymmetrical services in future packet services. An arrow direction of each slot indicates whether the slot is uplink or downlink. And TS0 is a downlink time slot.

In the example, the parameters of the TD-SCDMA system are as follows:

A sub-frame is 5 ms long, a common slot (TS0˜TS6) is 675 us long, the downlink pilot time slot (DwPTS) is 75 us long, the uplink pilot time slot (UpPTS) is 125 us long and the guard period (GP) is 75 us. The ratio adopted to allocate slots TS1˜TS6 for uplink and downlink is 4:3 or 5:2.

Mobile WiMAX Frame Structure

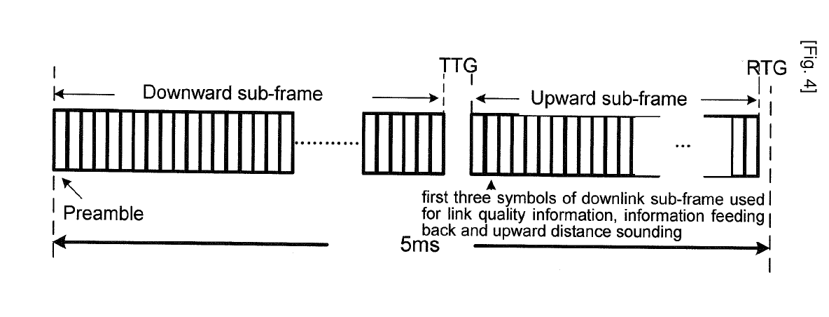

Many options exist in the design of mobile WiMAX parameters, all of which are defined in reference 3 (WiMAX Forum, WiMAX Forum™ Mobile System Profile 4 Release 1.0 Approved Specification 5 (Revision 1.2.2: 2006 Nov. 17)) And a frame is generally 5 ms long. The frame structure is shown in FIG. 4.

Here, a mobile WiMAX frame (5 ms) contains the uplink sub-frame and the downlink sub-frame. An uplink sub-frame starts with the Preamble. The transition points include: TTG (Transmit/receive Transition Gap) and RTG (Receive/transmit Transition Gap). The first three symbols in a downlink sub-frame are mainly used to feed back channel quality, to sound distance and to feed back ACK information. And the ratio between the lengths of uplink and downlink sub-frames can also be adjusted.

IEEE 802.16m Frame Structure

In this example, the parameters of the IEEE 802.16m TDD system are as follows:

A frame is 5 ms long, 1024-point FFT, 10 MHz bandwidth, oversample rate 11.2 MHz. The prefix is one eighth of length of a symbol. A symbol is 103 us long, TTG 106 us, and RTG 60 us;

At present, detailed design of IEEE 802.16m frame structure is in a pre-phase research of standardization. The options can be divided into following two categories:

a) Symbol-Based Frame Structure

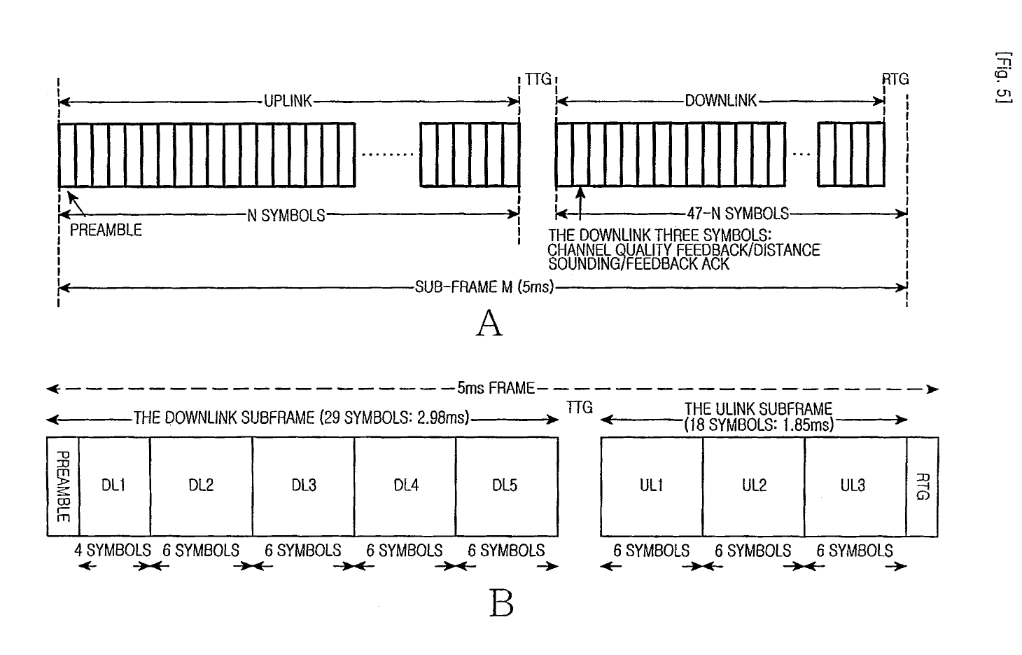

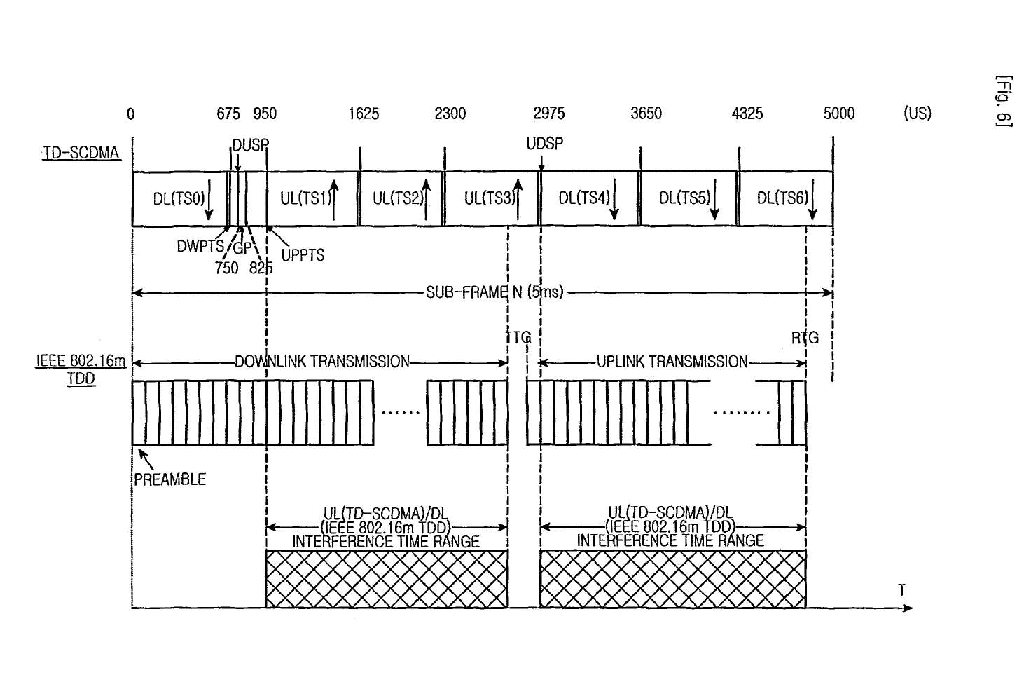

The design of symbol-based frame structure is consistent with that of parameters for mobile WiMAX system. The parameters and the design of the coexistence of TD-SCDMA and mobile WiMAX are suitable for an IEEE 802.16m (symbol-based) system. And the design of coexistence of TD-SCDMA and IEEE 802.16m (symbol-based) is also suitable for the mobile WiMAX system. The frame structure is shown in FIG. 5(a).

Here, a mobile WiMAX frame (5 ms) contains the uplink sub-frame and the downlink sub-frame. An uplink sub-frame starts with the Preamble. The transition points include: TTG (Transmit/receive Transition Gap) and RTG (RTG: Receive/transmit Transition Gap). The first three symbols in a downlink sub-frame are mainly used to feed back channel quality, to sound distance and to feed back ACK information. And the ratio between the lengths of uplink and downlink sub-frames can also be adjusted.

b) Frame Structure Based on Super Frame and/or Sub-Frame

The frame structure based on super frame and/or sub-frame is shown in FIG. 5(b). Each frame contains N sub-frames with each containing M symbols. Here, M and N are integers greater than or equal to one.

Typical structure and parameters are as follows: a frame is 5 ms long. In time order, it contains a one-symbol long Preamble, a four-symbol long downlink sub-frame, four six-symbol downlink sub-frames, the TTG, three six-symbol long uplink sub-frames and the RTG.

Total length of downlink time period: 29 symbols (one preamble and five downlink sub-frames in total, where the first sub-frame is composed of four symbols, and subframes 2˜5 each contain six symbols). The length of uplink time period is 18 symbols (three uplink sub-frames with each containing six symbols); And between the downlink/uplink transition period, there exists a TTG. Between the uplink/downlink transition period, there exists a RTG.

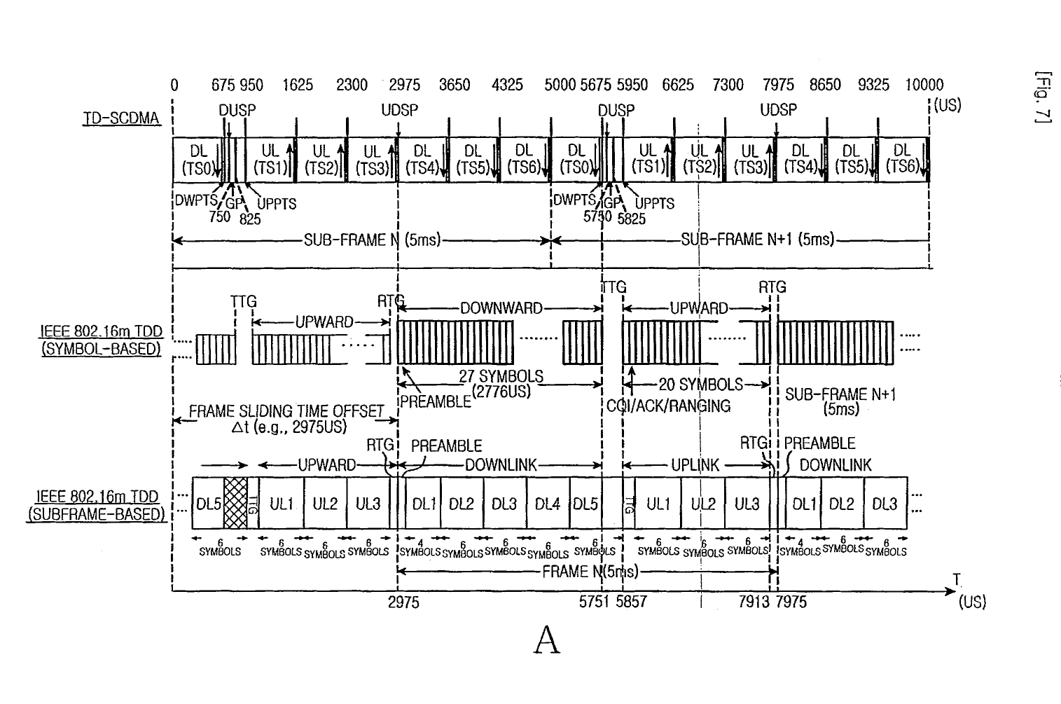

FIG. 6 shows the interference between TD-SCDMA system and IEEE 802.16m TDD system.

In which:
601 slot: in which the transmission of a TD-SCDMA MS causes interference to the receiving of an IEEE802.16m TDD MS.

When the MSs locate at the edges of corresponding cells and are not far from one another, greater interferences will be caused from the interference. Meanwhile 601 is a slot in which the transmission of an IEEE802.16m TDD BS causes interference to the receiving of a TD-SCDMA BS. Since the BS has high transmitting power and good transmitting conditions (in general, it has higher transmitting antenna so that it has larger coverage), greater interference is caused between BSs.
602 slot: in which the transmission of an IEEE802.16m TDD MS causes interference to the receiving of a TD-SCDMA MS.

When the MSs locate at edges of corresponding cells and are not far from one another, greater interferences will be caused from the interference. Meanwhile 602 is a slot in which the transmission of a TD-SCDMA BS causes interference to the receiving of an IEEE802.16m TDD BS. Since the BS has high transmitting power and good transmitting conditions (in general, it has higher transmitting antenna so that it has larger coverage), greater interference is caused between BSs.

Implementation Approach and Steps:

Step 1: the design coexistence frames for system 2 starts

Step 2 (204): the sub-frame ratio between downlink and uplink is configured for system 2, and then corresponding frame parameters are selected

To improve the utility of the coexistence system's wireless transmission resources, it is necessary to occupy the uplink and downlink transmission time slots as many as possible on the premise that the demand on the interference between systems can be well met. Therefore, in order to reduce the interference time area between system 1 and system 2, the sub-frame ratio between downlink and uplink can be determined for system 2 according to that for system 1. In general, the two ratios are kept consistent. By this ratio, the frame parameters including the lengths of uplink and downlink frames and the uplink/downlink transition periods (TTG and RTG) are determined.

This ratio can be one of several values but not unique. Coexistence design is implemented corresponding to each ratio.

In the embodiment, ratio between TD-SCDMA uplink and downlink time slots can be regulated by adjusting the allocation of the six common slots (TS1˜TS6). The common ratio configurations include:

4:3, i.e., ratio of 4:3 is adopted to allocate slots for downlink and uplink data transmission;

In an IEEE 802.16m (symbol-based) frame: number of downlink symbols can be 27, 26 or 25, and number of uplink symbols can be 20, 19 or 18;

In an IEEE 802.16m (sub-frame-based) frame: number of downlink symbols can be 27, 26 or 25, and number of uplink symbols can be 20, 19 or 18;

In following calculations, the number of downlink symbols is set to be 27, and the number of uplink symbols is set to be 20.

5:2, i.e., ratio of 5:2 is adopted to allocate slots for downlink and uplink data transmission;

In an IEEE 802.16m (symbol-based) frame: number of downlink symbols can be 33, 32 or 31, and number of uplink symbols can be 14, 13 or 12;

In an IEEE 802.16m (sub-frame-based) frame: number of downlink symbols can be 33, 32 or 31, and number of uplink symbols can be 14, 13 or 12;

In following calculations, the number of downlink symbols is set to be 33, and the number of uplink symbols is set to be 14.

Other possible ratio configurations between downlink and uplink for a TD-SCDMA frame include 1:5, 5:1, 0:6, 6:0 and 4:2. No description will be given here. Corresponding frame relative time offset Δt can be selected according to the approach proposed in the present invention.

Step 3 (201): the relative time offset Δt between the start moment of wireless frame in system 2 and that in system 1 is calculated

After the frame parameters are configured for system 2, a concept of the relative time offset Δt of the wireless frame start time between system 2 and system 1 is introduced in present invention. At refers to a time difference between the start moment T2 of wireless frame N in system 2 and the start moment T1 of the wireless frame in system 1 (e.g., frame M) whose start moment is immediately previous to that of frame N in system 2, i.e.,

Δt=T2−T1 and 0≦Δt<frame length.

The process of determining the relative time offset Δt of wireless frame between system 2 and system 1 contains following one substep or the combination of following two steps in preset order:

Substep 1: system 2 obtains information on system 1's clock source and/or frame's start moment

One of following two scenarios is included here:
The newly deployed system can directly obtain the information on clock source and/or frame start moment in the existing system.

This scenario happens in the case that the two systems belong to the same operator.

The newly deployed system can either use the clock source of the existing system as its own or as the input of its clock phase lock loop (PLL).
The newly deployed system is not able to directly obtain the existing system's clock source.

This scenario happens in the case that the two systems belong to the same operator.

With the receiver in the existing system, the newly deployed system can import the existing system's clock source as its own from the received signal, or as the input of its clock phase lock loop.

Substep 2: the relative time offset Δt between the start moment of wireless frame in system 2 and that in system 1 is calculated

Δt can be calculated with one of the methods below, or with the combination of them. And in the case of calculating with the combination of two or more listed methods, Δt is within the range of the intersection of results obtained with the applied methods (among the obtained results, the larger is the upper bound, and the smaller is the lower bound).

For the convenience of description, following parameters are introduced:

Frame Length: FL. System 1 shares the same frame length with system 2.

Parameters of System 1:
length of slot for uplink transmission: U_LTH1
length of slot for downlink transmission: D_LTH1
start moment of transmitting an uplink sub-frame: T1_UL
start moment of transmitting a downlink sub-frame: T1_DL
TTG length: TTG1
RTG length: RTG1

Parameters of system 2:
length of slot for uplink transmission: U_LTH2
length of slot for downlink transmission: D_LTH2
start moment of transmitting an uplink sub-frame: T2_UL
start moment of transmitting a downlink sub-frame: T2_DL
TTG length: TTG2
RTG length: RTG2

Method 1:

First, the reference time for system 1 is aligned with that for system 2. In this case, frames of the two systems are started to transmit at the same time. Then the downlink transmission time point for system 1 (which is the downlink transmission start point next to the TTG immediately), denoted by T1, is recorded; and the time point of the downlink transmission that is previous immediately to T1 for system 2 (which is the downlink transmission start point next to the TTG immediately), denoted by T2, is recorded. At denotes the difference T1−T2.

Method 2:

First, the reference time for system 1 is aligned with that for system 2. In this case, frames of the two systems are started to transmit at the same time. Then record the uplink transmission time point for system 1 (which is the uplink transmission start point next to the RTG immediately), denoted by T1; and record the time point of the uplink transmission that is previous to T1 immediately for system 2 (which is the uplink transmission start point next the to RTG immediately), denoted by T2. At denotes the difference T1−T2.

Method 3:

Suppose the lower bound of Δt be: (T1_UL−T2_DL−D_LTH2−TTG2) MOD (FL)

Suppose the upper bound of Δt be: (T1_DL−T2_UL−D_UTH2) MOD (FL)

Where (A)MOD(B) refers to the common modulo operation, i.e., modulo A with B.

Δt is greater than or equal to the lower bound but less than the upper bound.

That is to say, system 2 needs to meet the requirement that all newly deployed systems' uplink transmission slots are included in that of the existing system, i.e., the uplink transmission can not be implemented before the downlink transmission end point of system 1; meanwhile, the uplink transmission should not be finished later than the downlink transmission's start point of system 1.

Method 4:

Suppose the lower bound of Δt be: (T1_DL−T2_UL−D_UTH2−RTG2) MOD (FL)

Suppose the upper bound of Δt be: (T1_UL−T2_DL−D_DTH2) MOD (FL)

Where (A)MOD(B) refers to the common modulo operation, i.e., modulo A with B.

Δt is greater than or equal to the lower bound but less than the upper bound.

That is to say, system 2 needs to meet the requirement that system 2's all downlink transmission slots are included in that of the existing system, i.e., the downlink transmission can not be implemented later than the downlink transmission end point of system 1; meanwhile, the downlink transmission should not be implemented before the downlink transmission's start point of system 1.

Step 4 (202): the timing for system 2 is increased by the offset Δt for system 2 with respect to that for system 1, and the time reference for system 1 is added. System 2 uses the summation as its time reference for transmissions of uplink and downlink signals.

Step 5 (205): whether there is interference area between the wireless frames of system 2 and system 1 is estimated.

Whether there exists any interference time area or not is determined according to the projection areas of system 2 and system 1 on the time axis. If system 2's uplink and downlink transmission projection slots exceed that of system 1, we determine that there exists some interference time area.

Step 6 (203): system 2 reduces its transmission power or forces to zeros in corresponding interference time areas (206) and/or in protected significant slots in system 1.

If system 2 finds out that there exist relevant interference time area and/or the protected significant slots for system 1, it reduces its transmission power or forces to zero to reduce interference to system 1 under the coexistence environment.

The protected significant slots include but are not limited to a pilot transmission time slot, a signaling transmission time slot, a feedback information transmission time slot, an uplink access time slot, a synchronization time slot and a distance sounding time slot.

To reduce or zero enforcing the transmission power of all or some transmission time slots or symbols such as puncturing in all or some systems, protection can be provided to interference slots and/or significant slots in two or more systems.

Step 7: The design of the coexistence frame for system 2 is completed

The TD-SCDMA frame initial time plus Δt is used as the IEEE 802.16m system frame initial time for transmission.

1) If the ratio between the slots allocated for downlink and uplink data transmissions in the TD-SCDMA system is set to be 4:3 and method 1 is adopted here, and T1=2975 us, T2=0 us, the difference T1−T2, i.e., Δt=2975 us,

then the frame relative time offset Δt can be set to be 2975 us for the IEEE802.16m (symbol-based) system.

The frame relative time offset Δt can be set to be 2975 us for the IEEE 802.16m (sub-frame-based) system.

2) If the ratio between the slots allocated for downlink and uplink data transmissions in the TD-SCDMA system is set to be 5:2,

and method 1 is adopted here, and T1=2300 us, T2=0 us, the difference T1−T2, i.e., Δt=2300 us,

and method 2 is adopted here, and T1=5825 us, T2=2981 us, the difference T1−T2, i.e., Δt=2884 us,

then the frame relative time offset Δt can be set to be 2330 us (by method 1 and method 2, this offset is within the range [2300,2884]) for the IEEE802.16m (symbol-based) system.

Then the frame relative time offset Δt can be set to be 2741 us (by method 1 and method 2, this offset is within the range [2300,2884]) for the IEEE802.16m (sub-frame-based) system.

Where the implementation parameters of the IEEE 802.16m TDD (symbol-based) system are just the same as that of the mobile WiMAX system. They can be applied in the mobile WiMAX system.

According to the method proposed in the present invention, the system parameters can be obtained as follows:
4:3, i.e., ratio of 4:3 is adopted to allocate slots for downlink and uplink data transmission;

In this case, ratio between numbers of symbols for downlink and uplink in an IEEE 802.16m (symbol-based) frame can be set as 27:20 and the frame offset is set as 2975 us;

Under this configuration, the IEEE 802.16m (sub-frame-based) frame relative time offset Δt can be set as 2975 us. Where the downlink Preamble, the first downlink subframe (contains four symbols) and subframes 2˜4 (each contains six symbols) keep in service of data transmission. The first four symbols in the fifth subframe (contains 6 symbols in total) keep in service of data transmission while the rest two keep quiet to reduce possible interference between downlink and uplink.
5:2, i.e., ratio of 5:2 is adopted to allocate slots for downlink and uplink data transmission;

In this case, ratio between numbers of symbols for downlink and uplink in an IEEE 802.16m (symbol-based) frame can be set as 33:14 and the frame offset is set as 2330 us;

Under this configuration, the IEEE 802.16m (sub-frame-based) frame relative time offset Δt can be set as 2741 us. Where uplink subframes 1˜2 (each contains six symbols) keep in service of data transmission. The first two symbols in the third subframe (contains 6 symbols in total) keep in service of data transmission while the rest four keep quiet to reduce possible interference between downlink and uplink.

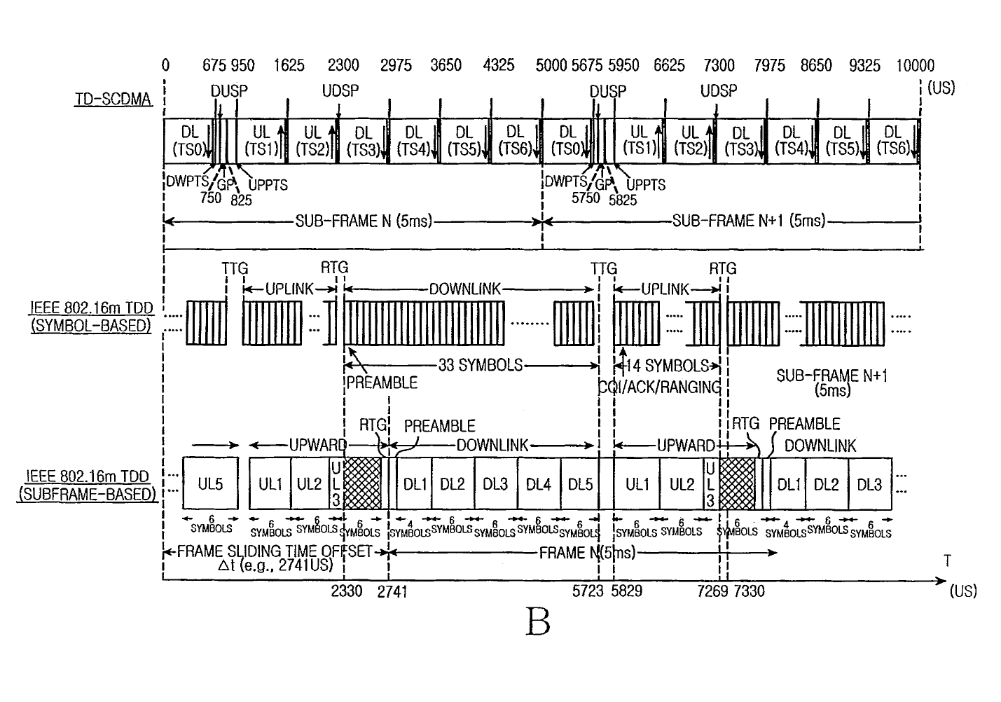

A schematic diagram for coexistence of TD-SCDMA (4:3) and IEEE 802.16m TDD is shown in FIG. 7(a).

A schematic diagram for coexistence of TD-SCDMA (5:2) and IEEE 802.16m TDD is shown in FIG. 7(b).

For example, the uplink pilot time slot (UpPTS) of a TD-SCDMA frame needs to be specially protected so as to guarantee that a TD-SCDMA uplink user's transmission parameters and channel can be correctly estimated by the BS. So for these slots that need special protection, the newly deployed IEEE 802.16m system should either implement no data transmission via the corresponding locations in the uplink transmission time slots or reduce the transmission power to avoid interference.

In addition, if the originally deployed system is an M-WiMAX one or an IEEE 802.16m one, the first three symbols in the uplink frame and the first symbol in the downlink frame need to be specially protected to guarantee that the M-WiMAX system or the IEEE 802.16m system could operate normally. So that for these slots that need significant protection, the newly deployed system should either implement no data transmission via the corresponding locations in the uplink transmission slots or reduce the transmission power to avoid interference.

1. A method for multiple TDD systems coexistence comprising steps of:
a newly deployed system calculating a relative time offset Δt for a corresponding frame;
the newly deployed system transmitting uplink and downlink signals based on a time reference information obtained by a summation of the relative time offset Δt and a time reference of an existing system.

2. The method according to claim 1, wherein two or more interference slots in system are protected by reducing or zero enforcing transmission power of one or more transmission slots or symbols such as puncturing for one or more systems.

3. The method according to claim 1, wherein two or more significant slots in system are protected by reducing or zero enforcing transmission power of one or more transmission slots or symbols such as puncturing for one or more systems.

4. The method according to claim 1, wherein the newly deployed system uses a clock source in the existing system as its own or as an input of its clock phase lock loop.

5. The method according to claim 1, wherein with a receiver in the existing system, the newly deployed system obtains a clock source in the existing system as its own from the received signal, or as an input of its clock phase lock loop.

6. The method according to claim 1, wherein the newly deployed system uses a frame start time of the existing system which starts earlier than a current frame of the newly deployed system immediately as a time reference, the reference time added by a time offset Δt, is set as a start time of a next frame in the newly deployed system.

7. The method according to claim 1, wherein the Δt meets at least one conditions as follows:
all uplink transmission time slots of the newly deployed system are included in uplink transmission time slots of the existing system;
all downlink transmission time slots of the newly deployed system are included in downlink transmission time slots of the existing system.

8. The method according to claim 1, wherein a range of frame time offset Δt is calculated with one or more following steps, in which in a case of calculating with two or more steps, Δt is within a range of an intersection set of results obtained with the steps used, and among the obtained results, the larger is an upper bound, and the smaller is a lower bound:
step 1: firstly a reference time for system 1 is aligned with that for system 2, in this case, frames of the two systems are started to transmit at the same time; then a downlink transmission time point for system 1 which is a downlink transmission start point next to a TTG immediately is recorded as T1; and a downlink transmission time point of a closest frame for system 2 which is a downlink transmission start point next to a TTG immediately is recorded as T2; Δt denotes a difference T1−T2;
step 2: firstly, the reference time for system 1 is aligned with that for system 2, in this case, frames of the two systems are started to transmit at the same time; then an uplink transmission time point for system 1 which an uplink transmission start point next to an RTG immediately is recorded as T1; and an the uplink transmission time point of a closest frame for system 2 which is an uplink transmission start point next to the RTG immediately is recorded as T2; Δt denotes a difference T1−T2;
step 3:
a lower bound of Δt is: (T1_UL−T2_DL−D_LTH2−TTG2) MOD (FL)
an upper bound of Δt is: (T1_DL−T2_UL−D_UTH2) MOD (FL)
where (A)MOD(B) is a modulo operation, i.e., modulo A with B;
Δt is greater than or equal to the lower bound but less than the upper bound;
step 4:
a lower bound of Δt is: (T1_DL−T2_UL−D_UTH2−RTG2) MOD (FL)
an upper bound of Δt is: (T1_UL−T2_DL−D_DTH2) MOD (FL)
where (A)MOD(B) is a modulo operation, i.e., modulo A with B;
Δt is greater than or equal to the lower bound but less than the upper bound.

9. The method according to claim 1, wherein an uplink to downlink transmission time slot allocation ratio is adjusted for the newly deployed system to maximize a time utility for uplink and/or downlink transmission(s).

10. The method according to claim 1, wherein time slots are allocated for uplink and downlink transmissions to make the newly deployed system have no transmission within a specific time slots of the existing system.

11. The method according to claim 1, wherein if the existing system is a TD-SCDMA system, a ratio between the number of slot symbols in downlink and uplink is configured as 4:3, the newly deployed system is IEEE802.16m or a mobile WiMAX, then the time offset the newly deployed system with respect to a latest frame of the existing system is 2975 us.

12. The method according to claim 1, wherein if the existing system is a TD-SCDMA system, a ratio between a number of slot symbols in downlink and uplink is configured as 5:2, the newly deployed system is a mobile WiMAX, a time offset the newly deployed system with respect to a latest frame of the existing system is 2300 us or 2741 us.

13. The method according to claim 1, wherein the existing system is a TD-SCDMA system, a ratio between the number of slot symbols in uplink and downlink is configured as 4:3, the newly deployed system is IEEE802.16m or a mobile WiMAX, symbols for uplink and downlink in the newly deployed system are allocated so that a number of symbols in the downlink is 27 or 26 or 25, and a number of symbols in the uplink is 20 or 19 or 18.

14. The method according to claim 1, wherein the existing system is a TD-SCDMA system, a ratio between a number of slot symbols in uplink and downlink is configured as 4:3, the newly deployed system is IEEE802.16m or a mobile WiMAX; in the newly deployed system, a downlink Preamble, a first downlink subframe containing four symbols and subframes 2˜4 each contains six symbols are used for data transmission; first four symbols in a fifth subframe containing 6 symbols are used for data transmission while last two symbols are not transmitted.

15. The method according to claim 1, wherein the existing system is a TD-SCDMA system, a ratio between a number of slot symbols in uplink and downlink is configured as 5:2, the newly deployed system is IEEE802.16m or a mobile WiMAX, then symbols for uplink and downlink in the newly deployed system are allocated so that a number of symbols in a downlink is 33 or 32 or 31, and a number of symbols in an uplink is 14 or 13 or 12.

16. The method according to claim 1, wherein the existing system is a TD-SCDMA system, a ratio between the number of slot symbols in uplink and downlink is configured as 5:2, the newly deployed system is IEEE802.16m or a mobile WiMAX; in the newly deployed system, uplink subframes 1˜2 each contains six symbols are used for data transmission; first two symbols in a third subframe containing 6 symbols are used for data transmission while last four symbols are not transmitted.

17. The method according to claim 1, wherein the existing system is a TD-SCDMA system, then within an uplink pilot time slot period of the existing system, the newly deployed system sets a state of its all or some uplink time slots as “no transmission” so that no uplink transmission is implemented by the newly deployed system within a transmission time corresponding to the uplink pilot time slot.

18. The method according to claim 1, wherein the existing system is a TD-SCDMA system, and the newly deployed system is IEEE802.16m or a mobile WiMAX; within a period for two uplink symbols in the uplink pilot slot of the TD-SCDMA system, the newly deployed system implements no uplink transmission so that no uplink transmission is implemented by the newly deployed system within a transmission time corresponding to the uplink pilot slot.

19. The method according to claim 2, wherein whether there exists any interference time area or not is determined according to projection areas of the existing system and the new deployed system on a time axis; if the uplink and downlink transmission projection slots of the newly deployed system exceed that of system 1, it is determined that there exists some interference time area, the exceeded transmission time area is considered as an interference area.

20. The method according to claim 3, wherein the protected significant slots include at least one of a pilot transmission slot, a signaling transmission slot, a feedback information transmission slot, an uplink access slot, a synchronization slot and a distance sounding slot.
